(19) United States
(12) Patent Application Publication
(10) Pub. No.: US 2020/0193035 A1
(43) Pub. Date: Jun. 18, 2020

(54) METHOD AND SYSTEM FOR DATA SECURITY VIA ENTROPY AND DISINFORMATION BASED INFORMATION DISPERSAL

(71) Applicant: Andres De Jesus Andreu, Cary, NC (US)

(72) Inventor: Andres De Jesus Andreu, Cary, NC (US)

(21) Appl. No.: 16/364,771

(22) Filed: Mar. 26, 2019

Related U.S. Application Data
(60) Provisional application No. 62/779,321, filed on Dec. 13, 2018.

(51) Int. Cl. G06F 21/60; G06F 21/78; H04L 9/08

(52) U.S. Cl. CPC G06F 21/602; H04L 2209/08; H04L 9/0861; G06F 21/78

(57) ABSTRACT

A system for computer data security via entropy and disinformation-based information dispersal. The system embodies deconstructing a data object into a superset of randomly sized shards and then, on a per shard basis, randomly choosing an encryption algorithm, randomly generating an encryption key, and initialization vector where appropriate, applying the randomly chosen encryption algorithm, generating an unique identifier to use for shard storage, placing at random offsets data distortion via randomly generated disinformation, and retrievably storing a superset of shards meta-data in a structured format.

### CROSS-REFERENCE TO RELATED APPLICATION

This application claims the benefit of priority of U.S. provisional application No. 62/779,321, filed 13-DEC-2018, the contents of which are herein incorporated by reference.

### BACKGROUND OF THE INVENTION

The present invention relates to data security and, more particularly, a method and system for computer data security via entropy and disinformation-based information dispersal.

Computer data elements (i.e. files, messages, etc.) that are complete and include a contiguous block of data are at high risk for offline security attacks. When a data element is complete (whether obfuscated or not) attackers have a great advantage so long as they can take the target contiguous block offline. These types of data security attacks place time on the attackers side so long as they have certain resources (i.e. strong computing power, quantum decryption capabilities, etc.). This risk applies to encrypted data as well since a complete data set (i.e. contiguous block) is susceptible to offline attacks based on advanced algorithms and/or sheer horsepower (as in the case of Quantum computing).

In short, the problem with existing solutions is that attackers can effectively reconstruct the original target data sets and effectively create powerful offline attack strategies, and so current data security systems do not provide a real deterrent—i.e., a challenging work factor—for attackers.

As can be seen, there is a need for a method and system for computer data security via entropy and disinformation-based information dispersal. Such an inherently-computer problem needs a computer-implemented solution that improves computer data security technology as embodied in the present invention, which provides a highly challenging work factor where it is near impossible to reconstruct an original data set such that it can be attacked offline.

By using entropy (i.e. randomness), at critical stages of the process, coupled with disinformation techniques, at strategic stages in the process, the information dispersal algorithm embodied by the present invention keeps attackers guessing and/or chasing worthless attack paths. This entropy disinformation combination, as a result, creates a situation where an attacker's work factor is raised to a very high level.

In sum, the extensive use of entropy/randomness at various layers coupled with disinformation, yields a stronger data security posture than anything currently seen in the field today.

### SUMMARY OF THE INVENTION

In one aspect of the present invention, a computer-implemented method of data security includes the following: receiving one or more data objects, irrespective of the source (i.e. data storage service, ingress via API, etc); deconstructing each data object into a superset of randomly sized shards; randomly choosing an encryption algorithm for each shard of the superset of shards; randomly generating an encryption key, and where applicable initialization vectors as well, for each shard of the superset of shards; encrypting each shard of the superset of shards using the randomly generated encryption key/initialization vector, respectively; providing a universal unique identifier for each shard of the superset of shards in encrypted form; and retrievably storing meta-data of the superset of shards in a data storage system.

In another aspect of the present invention, the computer-implemented method of data security includes the following receiving one or more data objects irrespective of the source (i.e. data storage service, ingress via API, etc); deconstructing each data object into a superset of randomly sized shards; randomly choosing an encryption algorithm for each shard of the superset of shards; randomly generating an encryption key, and where applicable initialization vectors as well, for each shard of the superset of shards; encrypting each shard of the superset of shards using the randomly generated encryption key/initialization vector, respectively; providing a universal unique identifier for each shard of the superset of shards in encrypted form; providing data distortion to each shard of the superset of the shards via randomly generated disinformation, wherein the data distortion is placed at a random offset; and retrievably storing meta-data of the superset of shards in a data storage system.

These and other features, aspects and advantages of the present invention will become better understood with reference to the following drawings, description and claims.

### BRIEF DESCRIPTION OF THE DRAWINGS

FIG. 1 is a flowchart of an exemplary embodiment of the present invention; and

FIG. 2 is a flowchart of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a system for computer data security via entropy and disinformation-based information dispersal. The system embodies deconstructing a data object into a superset of randomly sized shards and then, on a per shard basis, randomly choosing an encryption algorithm, randomly generating an encryption key, and initialization vector where appropriate, applying the encryption algorithm, generating an identifier to use for shard storage, placing, at random offsets, data distortion via randomly generated disinformation, and retrievably storing all relevant meta-data in a structured format.

The present invention may include at least one computer with a user interface. The computer may include at least one processing unit coupled to a form of memory. The computer may include, but not limited to, a microprocessor, a server, a desktop, laptop, and smart device, such as, a tablet and smart phone. The computer includes a program product including a machine-readable program code for causing, when executed, the computer to perform steps. The program product may include software which may either be loaded onto the computer or accessed by the computer. The loaded software may include an application on a smart device. The software may be accessed by the computer using a web browser. The computer may access the software via the web browser using the internet, extranet, intranet, host server, internet cloud and the like.

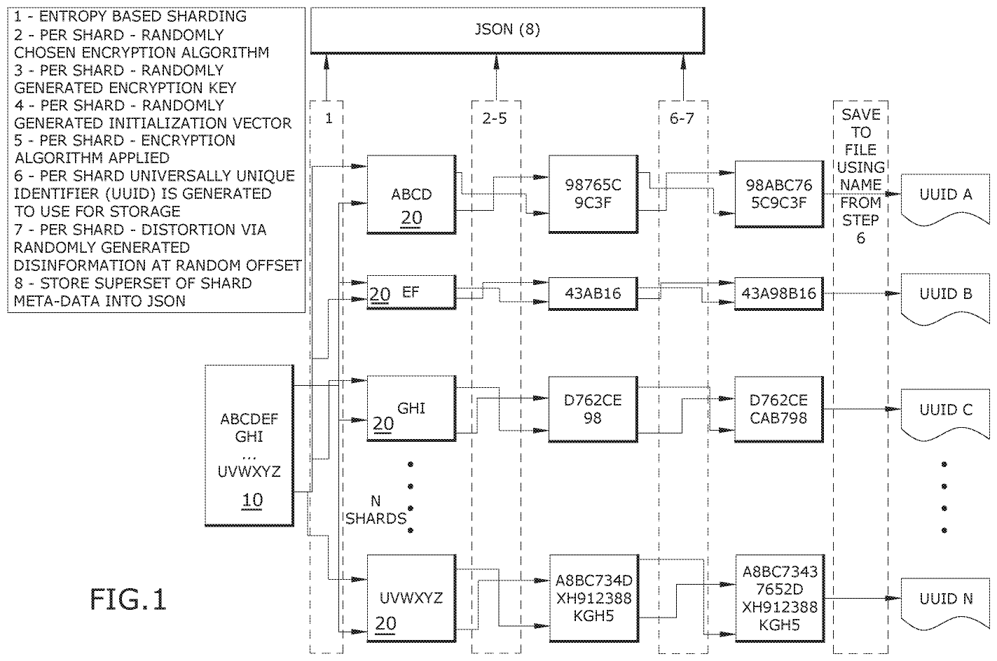

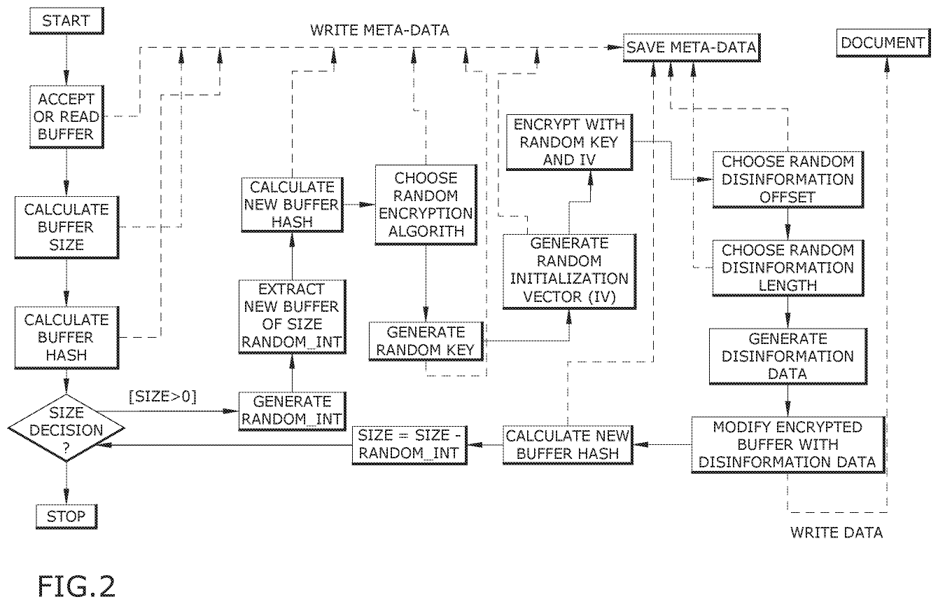

Referring now to FIGS. 1 and 2, the present invention may provide a method and system for computer data security via entropy and disinformation-based information dispersal. The entropy-based sharding method embodies the following components: (1) deconstructing a data object 10 into randomly sized shards 20, wherein each shard 20 may be a collection of data that lacks enough information for constructing the original and complete data object 10, yet that, in connection with one or more other shards 20, can be used to construct the data object, but only with a proper superset of shards 20; (2) per shard 20—randomly chosen encryption algorithm; (3) per shard 20—randomly generated encryption key; (4) per shard 20—randomly generated initialization vector; (5) per shard 20—encryption algorithm applied; (6) per shard 20—universally unique identifier (UUID) is generated to use for shard storage; (7) per shard 20—data distortion via randomly generated disinformation placed at random offset; and (8) storing superset of shards 20 meta-data into a structured format, such as JavaScript Object Notation (JSON).

During sharding the systemic software takes a complete data set (i.e. the superset or contiguous block of target data) and splits it into randomly sized shards, each named with randomly generated UUID's as the resulting file name. For each shard that gets generated as a subset of the original superset a random encryption algorithm is picked and random key/initialization-vector (where appropriate) is generated. Then this shard is obfuscated with that random set of encryption elements. Beyond that a random set of disinformation data is added to the obfuscated shard where the disinformation data is actually embedded at random offsets in the stored obfuscated end result of this entire process. The meta-data for each shard is then stored into a JSON object that holds all relevant details for when an entity needs to reconstruct the original data set.

There may be many custom subroutines (written as functions) in the systemic software. They vary from the picking of random encryption algorithms to generating random UUID's, encryption keys, encryption initialization vectors, etc.

The systemic software can be run as a standalone entity or through an API server (i.e. HTTPS REST) and the objective would be to inject this process in the path of file storage or message transmissions. This could be setup as software or as blackbox (i.e., appliance) and set to look at an existing data store (NFS, SMB, CIFS, etc.) or put in place as a gateway that data flows through.

The computer-based data processing system and method described above is for purposes of example only, and may be implemented in any type of computer system or programming or processing environment, or in a computer program, alone or in conjunction with hardware. The present invention may also be implemented in software stored on a computer-readable medium and executed as a computer program on a general purpose or special purpose computer. For clarity, only those aspects of the system germane to the invention are described, and product details well known in the art are omitted. For the same reason, the computer hardware is not described in further detail. It should thus be understood that the invention is not limited to any specific computer language, program, or computer. It is further contemplated that the present invention may be run on a stand-alone computer system, or may be run from a server computer system that can be accessed by a plurality of client computer systems interconnected over an intranet network, or that is accessible to clients over the Internet. In addition, many embodiments of the present invention have application to a wide range of industries. To the extent the present application discloses a system, the method implemented by that system, as well as software stored on a computer-readable medium and executed as a computer program to perform the method on a general purpose or special purpose computer, are within the scope of the present invention. Further, to the extent the present application discloses a method, a system of apparatuses configured to implement the method are within the scope of the present invention.

It should be understood, of course, that the foregoing relates to exemplary embodiments of the invention and that modifications may be made without departing from the spirit and scope of the invention as set forth in the following claims.

What is claimed is:

1. A computer-implemented method, comprising:
receiving one or more data objects, irrespective of the source;
deconstructing each data object into a superset of randomly sized shards;
randomly choosing an encryption algorithm for each shard of the superset of shards;
randomly generating an encryption key, and initialization vector where appropriate, for each shard of the superset of shards;
encrypting each shard of the superset of shards using the randomly generated encryption key, respectively;
applying to each shard the randomly chosen encryption algorithm, respectively;
providing a universal unique identifier for each shard of the superset of shards in encrypted form; and
retrievably storing meta-data of the superset of shards in a data storage system.

2. The method of claim 1, further providing data distortion to each shard of the superset of the shards via randomly generated disinformation.

3. The method of claim 1, wherein the data distortion is placed at a random offset.

4. The method of claim 1, wherein the data storage system is a structured format.

5. The method of claim 1, comprising in lieu of generating an encryption key:
randomly generating an initialization vectors for each shard of the superset of shards; and
encrypting each shard of the superset of shards using the randomly generated initialization vector, respectively.

6. A computer-implemented method, comprising:
receiving one or more data objects, irrespective of the source;
deconstructing each data object into a superset of randomly sized shards;
randomly choosing an encryption algorithm for each shard of the superset of shards;
randomly generating an encryption key, and initialization vector where appropriate, for each shard of the superset of shards;
encrypting each shard of the superset of shards using the randomly generated encryption key/initialization vector, respectively;
applying to each shard the randomly chosen encryption algorithm, respectively;
providing a universal unique identifier for each shard of the superset of shards in encrypted form;
providing data distortion to each shard of the superset of the shards via randomly generated disinformation, wherein the data distortion is placed at a random offset; and
retrievably storing meta-data of the superset of shards in a structured format data storage system.
